(19) United States
(12) Patent Application Publication
(10) Pub. No.: US 2008/0189970 A1
(43) Pub. Date: Aug. 14, 2008

(54) MEASUREMENT GAP PATTERN SCHEDULING TO SUPPORT MOBILITY

(75) Inventors: Jin Wang, Central Islip, NY (US); Peter S. Wang, East Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/970,954

(22) Filed: Jan. 8, 2008

Related U.S. Application Data
(60) Provisional application No. 60/883,937, filed on Jan. 8, 2007.

(51) Int. Cl. G01B 5/14

(52) U.S. Cl. 33/701; 33/700

(57) ABSTRACT

A method for taking measurements by a user equipment (UE) during a measurement gap begins with taking UE-specific measurements. The UE requests a measurement gap from a wireless network, the request including the UE-specific measurements. The UE receives measurement gap information from the network, including when the measurement gap is scheduled. The UE takes the measurements during the scheduled measurement gap.

### CROSS REFERENCE TO RELATED APPLICATION

This application claims the benefit of U.S. Provisional Application No. 60/883,937, filed Jan. 8, 2007, which is incorporated by reference as if fully set forth herein.

### FIELD OF THE INVENTION

The present invention is related to wireless communications.

### BACKGROUND

The objective of Evolved UTRA (universal terrestrial radio access) and UTRAN (UMTS (Universal Mobile Telecommunications System) terrestrial radio access network) is to develop a radio access network towards a high data rate, low-latency, packet-optimized system with improved system capacity and coverage. In order to achieve this, an evolution of the radio interface as well as the radio network architecture should be considered. For example, instead of using code division multiple access (CDMA; which is currently used in Third Generation Partnership Project (3GPP)), orthogonal frequency division multiple access (OFDMA) and frequency division multiple access (FDMA) are proposed air interface technologies to be used for downlink and uplink transmissions, respectively.

In order to support mobility in E-UTRAN, the user equipment (UE) should be able to perform handover-related measurements on the neighbor cells. The neighbor cell measurements are performed in a wide range of realistic and typical deployment scenarios, which include cells on the serving frequency layer, cells belonging to another frequency, or cells employing other access technologies such as UTRAN and GERAN (GSM Edge radio access network) systems.

Different types of handovers that are supported by E-UTRA are shown in FIG. 1. This classification is helpful to understand which type of handover measurements need to be carried out during the idle gaps. An “idle gap” is a period of time in which a UE knows that it will not receive any downlink data, and is also referred to herein as a “measurement gap”.

Intra-LTE (long term evolution) handovers are performed within the serving or non-serving E-UTRA frequency band. Inter-LTE handover refers to inter-RAT (radio access technology) handover, which corresponds to handover to UTRA or GERAN systems.

The intra-frequency handovers within E-UTRA can be further classified into two categories, which are handover within the same frequency band, but can be either within or outside the receiving bandwidth. Gap measurement is needed for all scenarios except one case: handover within the same frequency band and within the same reception bandwidth. This is different from the situation in a pre-LTE system.

In a wideband CDMA (WCDMA) system, frequency division duplex (FDD) is essentially continuous operation in the dedicated mode, and therefore gaps need to be created artificially. On command from the UTRAN, a UE monitors cells on other FDD frequencies and on other modes and RATs that are supported by the UE (i.e., TDD, GSM). The compressed mode is used in the CELL_DCH state only due to the continuous transmission nature of FDD. To allow the UE to perform measurements, the UTRAN commands the UE to enter compressed mode, depending on the UE capabilities.

In UE idle mode, URA_PCH, and CELL_PCH states, the compressed mode is not needed for inter-frequency and inter-RAT measurements because there is no continuous reception of any channel. The paging channel (PICH/PCH) is based on discontinuous reception (DRX) and the broadcast channel (BCH) of the serving cell is only required when system information changes. In the CELL_FACH state, there are forward access channel (FACH) measurement occasions that are used to generate the equivalent connection management (CM) gap (except that these FACH occasions are increments of frames rather than timeslots) and can reasonably be used for inter-frequency and inter-RAT measurements.

Because the LTE system uses OFDMA, the compressed mode used in the WCDMA system is no longer applicable in the OFDMA-based LTE system, and therefore scheduled gap measurement is proposed. Certain measurements in an LTE system will need to be “gap-assisted”, which means that the E-UTRAN needs to provide a period in which the UE can know that no downlink data will be scheduled for it. This gap allows the UE to take measurements of cells serving on a different frequency. In the case of intra-frequency measurements, there should be no conflict between taking measurements and data reception. The UE is already listening to the carrier and should be able to take measurements without any special requirements. For inter-frequency and inter-RAT measurements, however, the UE needs to tune away from the current downlink channel without missing the scheduled data (which is achieved by compressed mode in UMTS).

The static scheduling of the compressed mode is not flexible and is poorly suited to an all packet switched (PS) environment with scheduled data and short transmission time intervals (TTIs). Thus, it is necessary to replace the compressed mode in E-UTRAN with a different way of scheduling measurements.

To avoid data loss, the E-UTRAN and the UE need to agree on the timing of the gap during which no downlink data will be scheduled for the UE. This synchronization procedure needs to have the lowest latency possible to minimize data queuing in the network. There are two proposed solutions to this problem: network directed scheduling gaps and UE requested scheduling gaps.

In network directed scheduling, the network side determines when the UE should perform inter-RAT and inter-frequency measurements. In UE requested scheduling, the UE requests a measurement gap from the E-UTRAN and the E-UTRAN either grants or denies the request. If the UE is operating with bursty traffic, it may never request a gap because there may be enough time to perform the required measurements when the UE is not in active communication (e.g., in the “E-MAC periodic” or in the “E-MAC inactive” states).

The following problems have been identified from existing proposed solutions related to inter-frequency and inter-RAT handovers for an LTE system.

(1) When different measurement purposes (e.g., FDD, TDD, etc.) are required in LTE, scheduling only one transmission gap pattern sequence for one measurement purpose (e.g., FDD) is not sufficient. For example, the UE has to perform inter-frequency measurement to support intra-LTE handover and inter-RAT measurement to support inter-RAT handover to GERAN. In UMTS, different gap pattern sequences are scheduled to support different measurement purposes, but that scheme (which is purely network scheduled and controlled) may not be suitable for an LTE system.

(2) If the measurement gap is solely scheduled by the network, then the network scheduled gap cannot accurately reflect the UE's current situation such as UE mobility, trajectory (moving trend), distribution inside the cell, distance to the cell center, and the UE's speed/efficiency/ability in terms of measuring inter-frequency and/or inter-RAT cells. Thus, the network scheduled measurement gap may either over-allocate the downlink bandwidth, leading to a waste of radio resources, or under-allocate bandwidth, thereby preventing the UE from being able to perform the required measurements.

(3) If UE autonomous measurement is used to support inter-frequency or inter-RAT in LTE, the UE can make the required measurements based on its own sensing and detection of downlink traffic and channel conditions, with only the measured results reported to the E-UTRAN. But the E-UTRAN may not need the UE to perform those measurements, and the UE does not know the overall network conditions. This lack of knowledge by the UE can cause unnecessary data processing, a waste of UE power, and the UE may not measure the right cells at the right moment, which can result in measured results that are not needed nor useful.

(4) If UE autonomous measurement is used for UE assisted gap scheduling, the UE requests a measurement gap and the E-UTRAN grants the UE request. According to one proposed solution, the resources for the gap measurement are scheduled on a per UE request and a per grant basis, i.e., the UE has to request each measurement gap and the E-UTRAN has to grant each UE request. This frequent request/grant operation wastes radio resources and is inefficient.

(5) If the E-UTRAN grants a strict idle gap pattern, the pre-determined gap duration will probably interact with hybrid automatic repeat request (HARQ) transmissions and retransmissions when the idle gap comes. Such an interaction will pause the on-going HARQ delivery, which increases buffer occupancy, increases the combining and re-ordering burden at the receiver, and/or delays the transmission when a delay sensitive service such as voice over IP (VoIP) is supported.

(6) If the UE has finished taking the measurements before the end of one scheduled measurement gap, it has to send some information to the E-UTRAN to request an early return to the serving cell for normal transmission. One proposed solution uses a channel quality indicator (CQI) report to achieve this objective, but that proposal is not aware that the resources used for this kind of reporting are not available. Thus, using the CQI reporting in such a manner is not achievable.

### SUMMARY

In one embodiment, one or more transmission gap pattern sequences can be scheduled by the E-UTRAN to complete different measurement purposes for LTE. One transmission gap pattern sequence can be scheduled to finish all required measurement purposes, or one gap pattern sequence can be scheduled to finish several measurement purposes based on the UE report.

In a second embodiment, the E-UTRAN allocates the resources for UE gap measurement by considering reports on UE mobility, UE trajectory (moving trend), channel conditions, distance to the cell (eNB), cell deployment, etc.

In a third embodiment, the gap is scheduled with a certain duration (on more than one gap basis). The scheduled gap pattern can be adjusted before the end of the scheduled gap duration whenever the E-UTRAN detects that the latest UE situation change triggers the need to change the gap pattern.

In a fourth embodiment, the length of each gap is adaptive to accommodate the transmission and retransmissions of one HARQ process. This adaptation is signaled to the UE to avoid loss of data reception.

In a fifth embodiment, dedicated uplink resources, synchronous random access channel (RACH), or asynchronous RACH can be used to indicate an early return to normal communication in the serving cell before the end of one gap within the gap pattern sequence. The dedicated uplink resource is preferably allocated in an efficient way for this purpose.

A method for taking measurements by a user equipment (UE) during a measurement gap begins with taking UE-specific measurements. The UE requests a measurement gap from a wireless network, the request including the UE-specific measurements. The UE receives measurement gap information from the network, including when the measurement gap is scheduled. The UE takes the measurements during the scheduled measurement gap.

A method for scheduling a measurement gap begins by receiving a request for a measurement gap from a UE, the request including UE-specific measurements. The measurement gap is scheduled based on the received measurements and measurement gap information is signaled to the UE, whereby the UE can take measurements during the scheduled measurement gap. A base station or other network entity, such as an eNode B may be configured to perform this method.

### BRIEF DESCRIPTION OF THE DRAWINGS

A more detailed understanding may be had from the following description, given by way of example and to be understood in conjunction with the accompanying drawings, wherein:

FIG. 1 is a diagram of handover scenarios supported by E-UTRA;

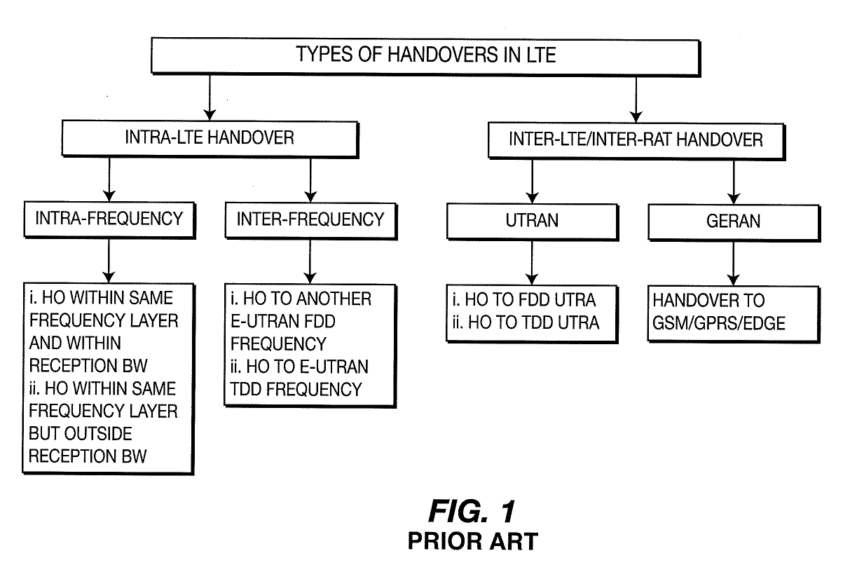

FIG. 2 shows a measurement gap pattern and associated parameters;

FIG. 3 is a flow diagram of a measurement gap signaling method;

FIG. 4 is a flowchart of a method to configure a length of time between two measurement gaps based on UE velocity;

FIG. 5 is a flowchart of a method to configure a length of time between two measurement gaps based on UE pathloss;

FIG. 6 is a block diagram of a first UE embodiment and a base station configured to implement the method shown in FIG. 3; and

FIG. 7 is a block diagram of a second UE embodiment and a base station configured to implement the method shown in FIG. 3.

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

Although in the following description an E-UTRAN is used as the source for making the gap scheduling decision, the gap scheduling decision may be made by any part of a network, depending on the particular architecture. For discussion purposes, the E-UTRAN functionality described herein occurs at a base station. In an LTE system, the same functionality as described herein as being in a base station could be in an enhanced Node B (eNB). Besides the strict network scheduled or UE only autonomous gap measurement, the UE request and E-UTRAN grant measurement gap scheduling to support inter-frequency and inter-RAT handover measurement can be used in an LTE system.

Measurement Gap Pattern Scheduling for Different Measurement Purposes

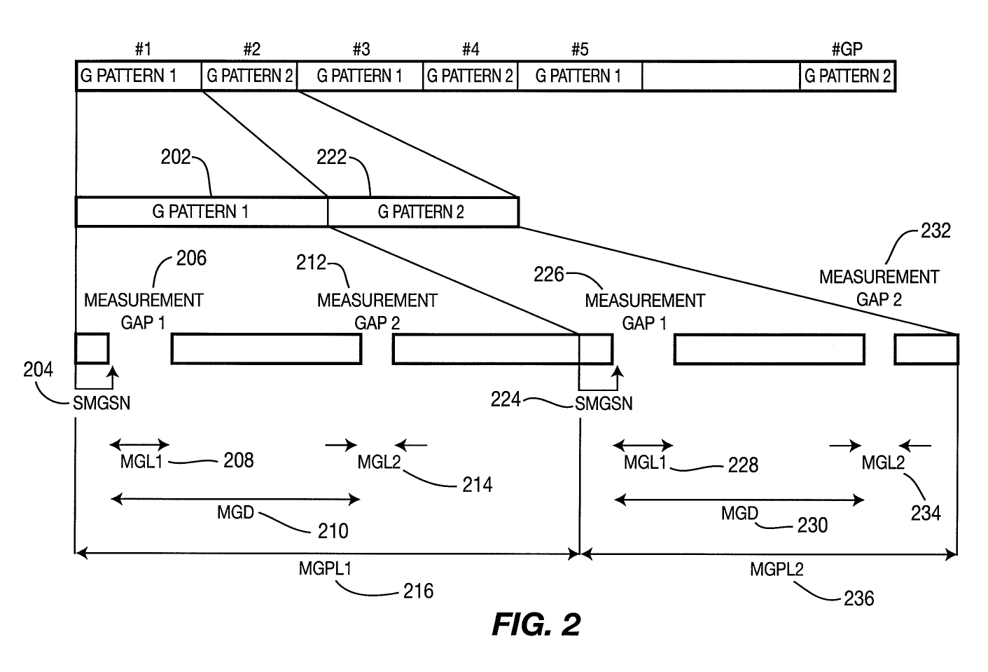

To accommodate different measurement purposes such as inter-frequency handover within an LTE system, inter-RAT handover which needs FDD, TDD, GSM carrier RSSI measurement, GSM initial base station identity code (BSIC) identification, BSIC re-confirmation, etc., special considerations should be given to the scheduled gap pattern sequence by the E-UTRAN. FIG. 2 shows the relationship between the measurement gap pattern sequence, the measurement gap, and associated scheduling parameters such as gap pattern (GP; a numerical identifier for the gap pattern), starting measurement gap sequence number (SMGSN; an identifier of a subframe where the first gap in the gap pattern is located and is used by the UE to locate where the gap pattern will start), measurement gap length (MGL; the length of the measurement gap in subframes, TTIs, or an absolute time value in milliseconds), measurement gap duration (MGD; the length of time from the start of a measurement gap to the start of the next measurement gap), and measurement gap pattern length (MGPL; the length of the entire gap pattern). These parameters are included in information elements (IEs) when the scheduled gap pattern is signaled to the UE, either through radio resource control (RRC) signaling or medium access control (MAC) signaling.

For example, a first gap pattern (G pattern 1) 202 includes a SMGSN 204, a first measurement gap (measurement gap 1) 206 having a first MGL (MGL1) 208 and an MGD 210. A second measurement gap (measurement gap 2) 212 has a second MGL (MGL2) 214. The entire first gap pattern has a first MGPL (MGPL1) 216. Similarly, a second gap pattern (G pattern 1) 222 includes a SMGSN 224, a first measurement gap (measurement gap 1) 226 having a first MGL (MGL1) 228 and an MGD 230. A second measurement gap (measurement gap 2) 232 has a second MGL (MGL2) 234. The entire first gap pattern has a first MGPL (MGPL1) 236.

There are several different approaches for the measurement gap pattern to support different measurement purposes.

In a first approach, the UE supports a single measurement purpose by using only one transmission gap pattern sequence. The measurement purpose of the transmission gap pattern sequence is signaled by higher layers (RRC) or MAC. The number of gap pattern sequences is equal to the number of measurement purposes, which depend on how many purposes the E-UTRAN requests the UE to support based on UE's situation and capability. If N measurement purposes are supported by the UE, then N different measurement gap pattern sequences should be scheduled.

The order of different measurement gap patterns for different measurement purposes should be defined and signaled to the UE. In RRC signaling, there can be a message indicating the order of different measurement gap patterns. For example, there can be a predefined alphabetic representation (or other short-hand format) for different measurement gap patterns. An ordered alphabetic representation of the gap patterns can be signaled to the UE, which indicates the order of the different measurement gap patterns. Besides the measurement purposes similar to those in UMTS, new measurement purposes are proposed to support scheduling the measurement gap pattern for inter-frequency cells within intra-LTE system. For example, in an LTE system, the UE measures LTE inter-frequency cells which are not present in UMTS.

In a second approach, one measurement gap pattern sequence is scheduled to support all different measurement purposes. If the UE is capable of handling all the necessary inter-frequency plus inter-RAT measurements, then only one gap pattern sequence needs to be scheduled.

In a first option for the second approach, each gap within the measurement gap pattern is scheduled to be long enough to perform all different measurement purposes. For this option, the measurement sequence for different purposes such as intra-LTE, FDD, etc. can be defined and signaled by E-UTRAN, or the UE decides the measurement sequence based on the UE's situation and capability. Using FIG. 2 as an example, because gap pattern 1 (202) and gap pattern 2 (222) are the same (i.e., measurement gap 1 (206, 226) and measurement gap 2 (212, 232) are of the same length in both gap patterns), the gap will be long enough to support all measurement purposes.

In a second option for the second approach, different gap lengths of 1 to M are scheduled in sequence to support different measurement purposes. Each gap supports one or more than one measurement purposes. The length of time between each gap should be signaled. The sequence of each gap to support different measurement purposes is preferably defined and signaled by the E-UTRAN.

In a third approach, one gap pattern is used to support several measurement purposes. This is a tradeoff to the first and second approaches described above. For example, one gap pattern can be used to support FDD, TDD, and GSM carrier RSSI measurement; a second gap pattern can be used to support initial BSIC identification and BSIC re-confirmation; and a third gap pattern can be used to support inter-frequency LTE measurement. Other alternative pairings of measurement purposes to a measurement gap pattern can be of any combination. The pairing between the measurement gap pattern and different measurement purposes is signaled from the E-UTRAN to the UE. For each gap pattern, both options described for the second approach are applicable.

Information to schedule the measurement gap pattern should be signaled from the RRC layer or the MAC layer (or possibly the PHY layer) from the E-UTRAN, or from a higher layer from the network side above the E-UTRAN. The following IE parameters should be signaled from the E-UTRAN to the UE. Depending on which measurement gap pattern scheme will be used, all or only part of these parameters need to be signaled, and are summarized in Table 1.

TABLE 1
IE Parameters For Measurement
Gap Pattern (GP) Scheduling

| Information | | | |
|---|---|---|---|
| Element/Group | | | |
| Name | Need | Type and Reference | Description |
| Number of | MP | Integer {0 . . . N} | |
| measurement purposes | | | |
| Measurement | MP | Enumerated | |
| Purposes | | {Inter-freq LTE, FDD, | |
| | | TDD, GSM carrier | |
| | | RSSI, Initial BSIC | |
| | | identification, BSIC re- | |
| | | confirmation, etc.} | |
| Measurement Gap | MP | Enumerated | |
| Pattern Scheme | | {Proposal 1, Proposal 2 | |
| | | with options, Proposal 3 | |
| | | with options} | |
| Pairing between | MP | Enumerated | One GP can support |
| Measurement Gap | | {GPi to | more than one |
| Pattern to | | MeasurementPurpose_x, etc.} | measurement purpose |
| Different | | | |
| Measurement | | | |
| Purposes | | | |
| Number of | MP | Integer {0 . . . N} | This is for second or |
| Different Gap | | | third approach when one |
| Types In One GP | | | GP will support more |
| | | | than one measurement |
| | | | purpose |
| Sequence of | MP | Enumerated | The sequence will be |
| Measurement | | {Inter-frequency LTE, | according to the |
| Purposes In One | | FDD, TDD, GSM carrier | assignment, but the |
| GP | | RSSI, Initial BSIC | elements are from the |
| | | identification, BSIC re- | those elements |
| | | confirmation, etc.} | |
| Number of | MP | Integer {0 . . . N} | For second or third |
| Measurement | | | approach when one GP |
| Purposes In One | | | will support more than |
| Gap of a GP | | | one measurement |
| | | | purpose |
| Sequence of | MP | Enumerated | The sequence will be |
| Measurement | | {Inter-frequency LTE, | according to the |
| Purposes In One | | FDD, TDD, GSM carrier | assignment, but the |
| Gap | | RSSI, Initial BSIC | elements are from the |
| | | identification, BSIC re- | those elements |
| | | confirmation, etc.} | |
| Measurement Gap | MP | Enumerated | These parameters apply |
| Pattern | | {GP, SMGSN, MGL, | to first, second and third |
| Parameters | | MGD, MGPL, etc.} | approach |
| GP | MP | Integer {0 . . . N} | Maximum number of GP |
| | | | is equal to number of |
| | | | measurement purpose |
| SMGSN | MP | Integer {0 . . . X} | The exact Max SN will |
| | | | be decided by LTE |
| | | | design |
| MGL | MP | Integer {0 . . . X} | MGL is in number of |
| | | | subframes or MP TTIs |
| | | | or time |
| MGD | MP | Integer {0 . . . X} | As above |
| MGPL | MP | Integer {0 . . . X} | As above |

The above proposals for the measurement gap pattern are independent of whether strict network scheduled, UE autonomous scheduled, or UE assisted and E-UTRAN scheduled gap scheduling is used.

Measurement Gap Pattern Scheduling

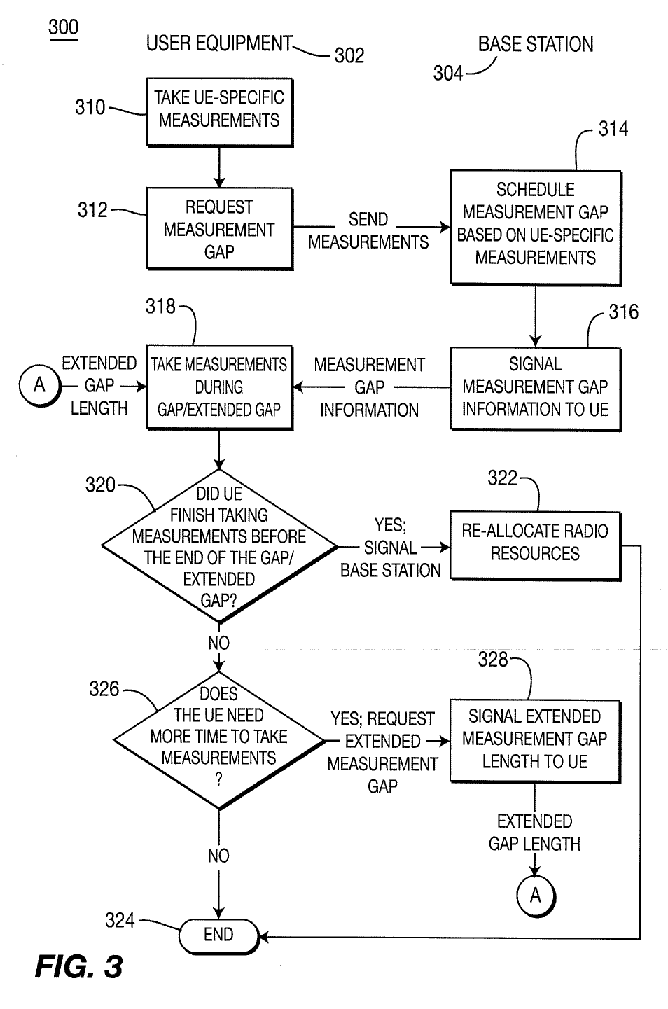

FIG. 3 is a flow diagram of a measurement gap signaling method 300 between a UE 302 and a base station 304. The UE 302 takes local environmental measurements, such as current location, mobility-related measurements (e.g., speed, direction, etc.), and downlink traffic and channel conditions (step 310). Based on these measurements, the UE 302 requests a measurement gap from the base station 304 (step 312). As part of the request, the local measurements taken by the UE 302 are sent to the base station 304. When the UE requests the measurement gap, the following factors are preferably measured and reported to the base station in the request: UE capability, UE mobility, UE trajectory, distance to the serving cell center (pathloss), UE channel condition, cell size, discontinuous reception (DRX) cycle, a number of measurement purposes that the UE wants to measure, etc.

The base station 304 schedules a measurement gap based on the UE-specific measurements (step 314). The measurement gap scheduled by the base station when requested by the UE can be more than one gap, which will reduce the frequent request and grant overhead. The base station preferably makes measurement gap scheduling by considering the above factors comprehensively and not based on one factor alone.

The UE capability determines whether the UE can make gap measurements for inter-frequency LTE, FDD, TDD, GSM carrier RSSI measurement, initial BSIC identification, BSIC re-confirmation, etc. Only the necessary gap measurements should be scheduled within the UE's capability limit.

The base station 304 then signals the measurement gap information to the UE 302 (step 316). The UE 302 takes the external measurements it needs during the scheduled measurement gap (step 318). A determination is made whether the UE finished taking its measurements before the end of the gap (step 320).

If the measurement gaps scheduled by the base station are too conservative, meaning that the gap is longer than needed to finish all requested measurement purposes, then waiting for the expiration of the full gap time is a waste of radio resources. If the UE has finished taking the measurements before the end of the gap, the UE 302 signals the base station 304 of its return to normal uplink or downlink reception in the current serving cell before the expiration of the gap time. The UE may use one of the following measures to indicate its return to normal reception.

1) The asynchronous RACH can be used to indicate the early end of the gap measurement. Due to the long latency and large overhead for this channel, this option may be a last choice compared with the following two options.

2) The synchronous RACH can be used to indicate the early end of the gap measurement.

3) When the base station assigns the measurement gap, a dedicated uplink channel can be assigned during the gap. The base station can indicate that the dedicated uplink channel can start from a certain subframe within each gap which is dependent on the measurement purpose and activity, etc. The UE can then utilize this dedicated uplink channel to report its early ending of measurement activity within one gap.

Upon detecting the early end indication, the base station re-allocates the radio resources for the remainder of the gap (step 322) and the method terminates (step 324).

If the UE did not finish taking the measurements early (step 320), then a determination is made whether the UE needs more time to take the measurements (step 326). The measurement gap pattern can be extended or adjusted based on the latest UE reporting information. The previous signaling to the UE defines one length for one measurement gap pattern. When the UE indicates that it needs a longer measurement gap, then the base station signals the UE to indicate the additional gap length beyond the previously signaled gap length that the UE can use for continued measurements (step 328) and the UE continues taking measurements during the extended gap (step 318). The UE indicates that it needs a longer measurement gap by using a periodic uplink channel (if available) or through the RACH process to send an indication to the eNB. For the gap pattern extension, the exact parameters can be the same as the previous pattern or different depending on the UE report. If the current measurement gap pattern is an extension to the previous one, and if the parameters of the gap pattern are all the same as previous pattern, then no more new parameters need to be signaled. Otherwise, new signaling is needed.

If the UE does not need more time to take measurements (step 326), then the method terminates (step 324).

After the measurement gap pattern is scheduled, the gap pattern starts from the assigned starting subframe. But the start of each gap may conflict with current HARQ operations. If the base station grants a strict idle gap pattern, the pre-determined gap duration will probably interact with HARQ transmissions and retransmissions when the gap begins. This interaction will pause the on-going HARQ delivery which increases buffer occupancy, increases the combining and re-ordering burden at receiver, or delays the transmission when a delay-sensitive service such as Voice over IP (VoIP) is supported.

Preferably, if even the start of the gap is scheduled by the base station at a fixed timing, it can be postponed by a number of subframes before the end of the on-going HARQ process. At the end of all HARQ retransmissions, the UE piggybacks an indication of the real start of the gap; or the gap can be inferred by the base station based on the maximum number HARQ retransmissions, acknowledgement status, etc.

The UE preferably extends the gap by the number of subframes that are delayed by HARQ processes, and the base station should delay the start of its downlink activity by the same number of subframes. By doing so, the adaptive gap length adjustment can be achieved above the base station scheduled gap pattern which can easily accommodate the HARQ process.

Scheduling the Length of Time between Two Consecutive Measurement Gaps

If the UE is moving at a high speed, then more measurement gaps should be scheduled, meaning that the length of time between two gaps can be shorter than when UE is moving at a relatively low speed. By doing this, the UE may have enough opportunity to measure inter-frequency or inter-RAT cells to make the correct handover decision at high mobility. Also, the UE can save power and use fewer radio resources when moving at a relatively low mobility but can still obtain enough measurements to make the correct handover decision.

The measurement gap information includes a default gap density (i.e., the length of time between two consecutive measurement gaps), but the gap density can be based on the UE mobility as compared to various thresholds. The default gap density can be used in any condition and at the beginning of a measurement gap period. If the UE's mobility has changed for a predetermined period of time, then the gap density may be adjusted. By requiring a change in the UE's mobility for a predetermined period of time, a ping-pong effect of rapid gap density changes can be avoided.

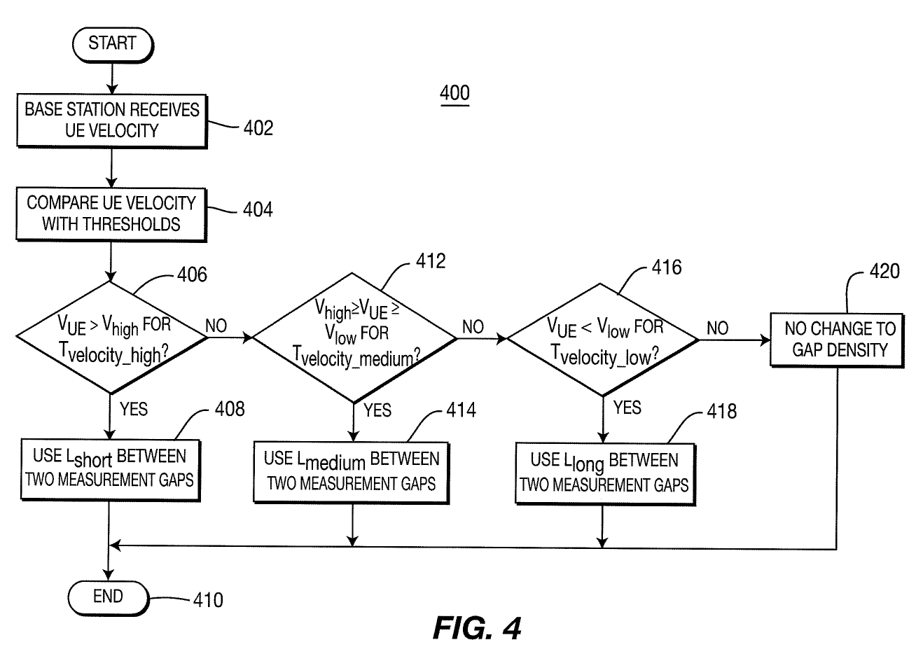

FIG. 4 is a flowchart of a method 400 to configure the measurement gap density based on UE velocity. As shown in FIG. 4, V indicates the UE's velocity (V_{UE}) and associated thresholds (V_{high}, V_{medium}, and V_{low}), T indicates the period of time that the UE's velocity is compared to the threshold (T_{velocity}_{_{—}}_{high}, T_{velocity}_{_{—}}_{medium}, and T_{velocity}_{_{—}}_{low}), and L indicates a length of time between two adjacent measurement gaps assigned to the UE. By forcing a length of time between two consecutive gaps, the UE is able to transmit and receive “regular” data and not spend too much time taking measurements.

The base station receives the UE's velocity information (step 402) and compares it with a plurality of thresholds (step 404). If the UE's velocity is greater than a high velocity threshold (V_{UE}>V_{high}) for a predetermined period of time (T_{velocity}_{_{—}}_{high}; step 406), then a short period of time (Lₛₕₒᵣₜ) between two consecutive measurement gaps is used (step 408) and the method terminates (step 410). If the UE's velocity is between the high velocity threshold and a low velocity threshold (V_{high}>=V_{UE}>=V_{low}) for a predetermined period of time (T_{velocity}_{_{—}}_{medium}; step 412), then a medium period of time (L_{medium}) between two consecutive measurement gaps is used (step 414) and the method terminates (step 410). If the UE's velocity is below the low velocity threshold (V_{UE}<V_{low}) for a predetermined period of time (T_{velocity}_{_{—}}_{low}; step 416), then a long period of time (L_{long}) between two consecutive measurement gaps is used (step 418) and the method terminates (step 410). If the UE's velocity does not satisfy any of the previous thresholds for the associated predetermined time period, then there is no change to the gap density (step 420), meaning that the default gap density or the most recent gap density value will continue to be used and the method terminates (step 410).

The UE trajectory (moving trend) and UE distribution in the serving cell is another factor. The UE trajectory can be combined with the UE's distance to the serving cell center for measurement gap scheduling, because sometimes the UE movement may indicate a circular trajectory around the cell center which may not provide useful information.

The UE distance (pathloss) to the serving cell center is another factor that can be used to determine the length of time between two consecutive measurement gaps. If the UE is moving toward the center of the serving cell, then fewer measurement gaps should be scheduled, meaning that the length between two gaps can be longer than the case when the UE is moving towards the cell edge. Pathloss can be a metric to indicate the UE distance to serving cell center.

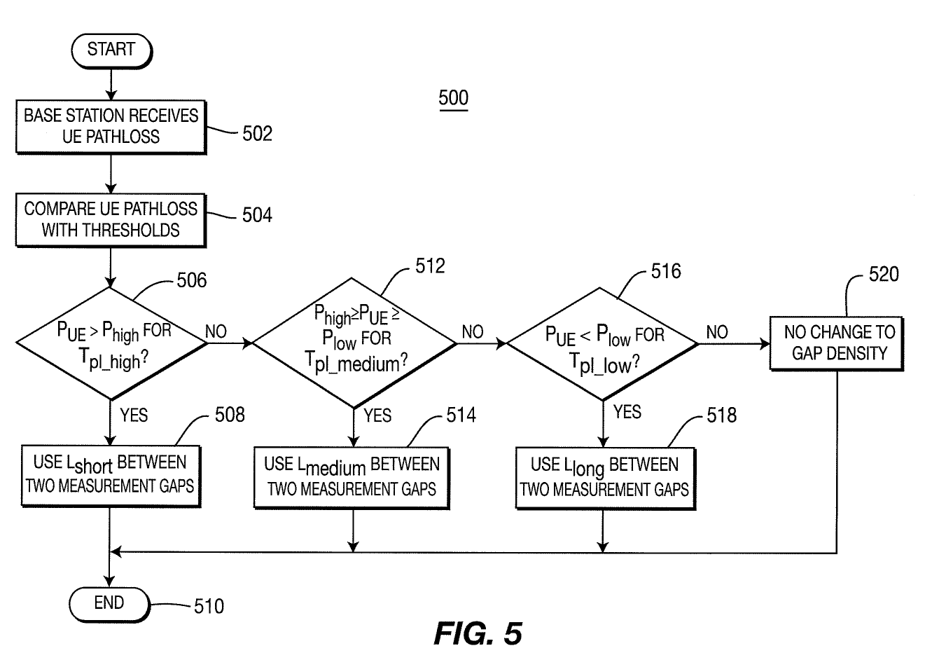

FIG. 5 is a flowchart of a method 500 to configure the measurement gap density based on UE pathloss. As shown in FIG. 5, P indicates the UE's pathloss (P_{UE}) and associated thresholds (P_{high}, P_{medium}, and P_{low}), T indicates the period of time that the UE's pathloss is compared to the threshold (Tₚₗ_{_{—}}_{high}, Tₚₗ_{_{—}}_{medium}, and Tₚₗ_{_{—}}_{low}), and L indicates the length of time between two adjacent measurement gaps assigned to the UE.

The base station receives the UE's pathloss information (step 502) and compares it with a plurality of thresholds (step 504). If the UE's pathloss is greater than a high pathloss threshold (P_{UE}>P_{high}) for a predetermined period of time (Tₚₗ_{_{—}}_{high}; step 506), then a short period of time (Lₛₕₒᵣₜ) between two consecutive measurement gaps is used (step 508) and the method terminates (step 510). If the UE's pathloss is between the high pathloss threshold and a low pathloss threshold (P_{high}>=P_{UE}>=P_{low}) for a predetermined period of time (Tₚₗ_{_{—}}_{medium}; step 512), then a medium period of time (L_{medium}) between two consecutive measurement gaps is used (step 514) and the method terminates (step 510). If the UE's pathloss is below the low pathloss threshold (P_{UE}<P_{low}) for a predetermined period of time (Tₚₗ_{_{—}}_{low}; step 516), then a long period of time (L_{long}) between two consecutive measurement gaps is used (step 518) and the method terminates (step 510). If the UE's pathloss does not satisfy any of the previous thresholds for the associated predetermined time period, then there is no change to the gap density (step 520), meaning that the default gap density or the most recent gap density value will continue to be used and the method terminates (step 510).

When both the UE's velocity and the UE's pathloss measurements are available, using the pathloss can produce better results because the distance of the UE from the cell center has a greater effect on determining the gap intervals. For example, when UE is close to the serving cell center, it is possible that no measurement gap needs to be scheduled.

Another factor that can be considered during measurement gap scheduling is the UE channel condition. When the UE is experiencing poor channel conditions, which can be indicated by a channel quality indicator (CQI), then the E-UTRAN may schedule resources for gap measurement instead of data transmission. By doing so, the network can avoid dropping packets with a high error rate and it is efficient to utilize this channel condition to make inter-frequency and inter-RAT measurements.

The density and number of the measurement gaps should be scheduled based on the serving cell size. If the serving cell size is small, more measurement gaps should be scheduled; otherwise fewer measurement gaps should be scheduled.

UE and Base Station to Implement Measurement Gap Pattern Scheduling

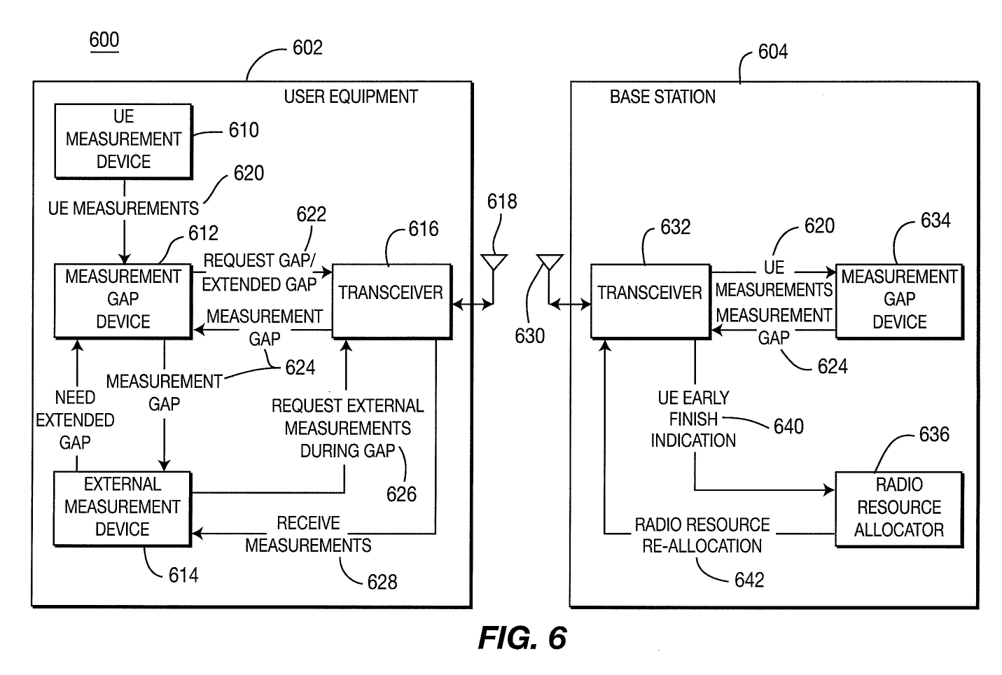

FIG. 6 is a block diagram of a system 600 including a UE 602 and a base station 604 configured to implement the method 300 shown in FIG. 3. The UE 602 includes a UE measurement device 610, a measurement gap device 612, an external measurement device 614, a transceiver 616, and an antenna 618. The base station 604 includes an antenna 630, a transceiver 632, a measurement gap device 634, and a radio resource allocator 636.

In operation, the UE measurement device 610 takes local environmental measurements at the UE 602. The measurements 620 are passed to the measurement gap device 612, which uses the measurements to construct a measurement gap request 622. The gap request 622 includes the UE measurements 620 and is sent to the measurement gap device 634. The measurement gap device 634 analyzes the UE measurements and schedules a measurement gap 624 for the UE 602. The measurement gap device 634 sends the measurement gap information 624 to the measurement gap device 612. The measurement gap device 612 forwards the measurement gap information 624 to the external measurement device 614.

The external measurement device 614 requests measurements from other base stations 626 and receives the measurements from the other base stations 628. If the external measurement device 614 completes the external measurements before the end of the assigned measurement gap, then the external measurement device 614 signals measurement gap device 612, which signals the base station 604 that the measurements have been completed before the end of the measurement gap 640. The radio resource allocator receives the indication 640 and re-allocates the radio resources for the remainder of the measurement gap 642. Similarly, if the external measurement device 614 needs additional time to complete the measurements, it signals the measurement gap device 612 to request an extended gap from the base station 604.

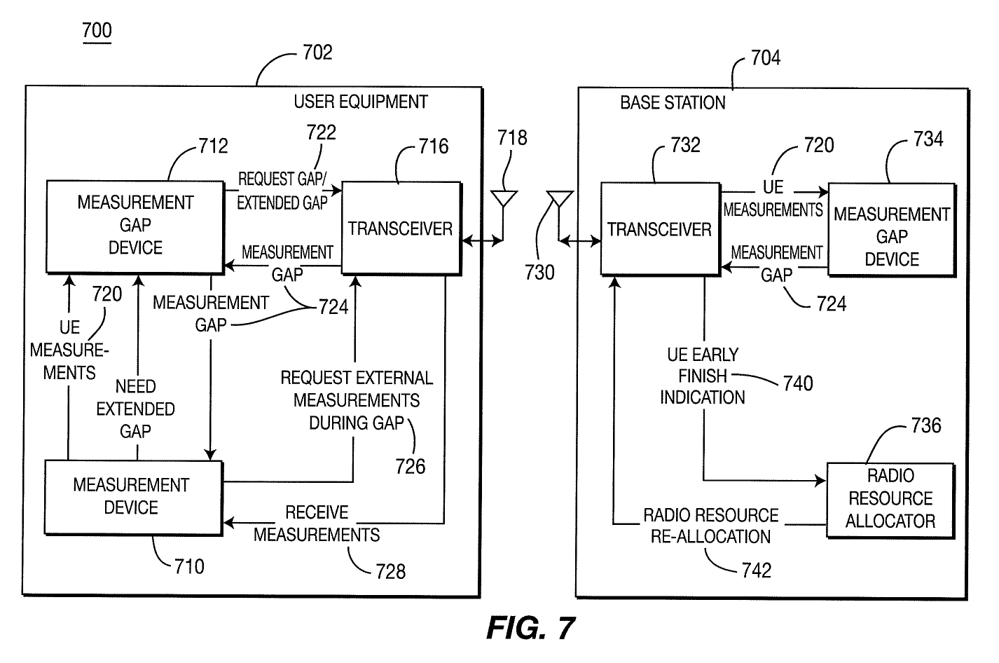

FIG. 7 is a block diagram of an alternate system 700 including a UE 702 and a base station 704 configured to implement the method 300 shown in FIG. 3. The UE 702 includes a measurement device 710, a measurement gap device 712, a transceiver 716, and an antenna 718. The base station 704 includes an antenna 730, a transceiver 732, a measurement gap device 734, and a radio resource allocator 736.

In operation, the measurement device 710 takes local environmental measurements at the UE 702. The measurements 720 are passed to the measurement gap device 712, which uses the measurements to construct a measurement gap request 722. The gap request 722 includes the UE measurements 720 and is sent to the measurement gap device 734. The measurement gap device 734 analyzes the UE measurements and schedules a measurement gap 724 for the UE 702. The measurement gap device 734 sends the measurement gap information 724 to the measurement gap device 712. The measurement gap device 712 forwards the measurement gap information 724 to the measurement device 710.

The measurement device 710 requests measurements from other base stations 726 and receives the measurements from the other base stations 728. If the measurement device 710 completes the external measurements before the end of the assigned measurement gap, then the measurement device 710 signals the measurement gap device 712, which signals the base station 704 that the measurements have been completed before the end of the measurement gap 740. The radio resource allocator receives the indication 740 and re-allocates the radio resources for the remainder of the measurement gap 742. Similarly, if the measurement device 710 needs additional time to complete the measurements, it signals the measurement gap device 712 to request an extended gap from the base station 704.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for taking measurements by a user equipment (UE) during a measurement gap, comprising:
taking UE-specific measurements;
requesting a measurement gap from a wireless network, the request including the UE-specific measurements;
receiving measurement gap information from the network, including when the measurement gap is scheduled; and
taking measurements during the scheduled measurement gap.

2. The method according to claim 1, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length.

3. The method according to claim 1, further comprising:
determining whether all measurements are taken before the end of the measurement gap;
sending an indication to the network if all the measurements are taken before the end of the measurement gap; and
requesting an extended measurement gap from the network if all the measurements are not taken before the end of the measurement gap.

4. A method for scheduling a measurement gap, comprising:
receiving a request for a measurement gap from a user equipment (UE), the request including UE-specific measurements;
scheduling a measurement gap based on the received measurements; and
signaling measurement gap information to the UE, whereby the UE can take measurements during the scheduled measurement gap.

5. The method according to claim 4, wherein said scheduling includes scheduling one measurement gap for each measurement purpose requested by the UE.

6. The method according to claim 5, wherein a different measurement gap is scheduled for each wireless technology to be monitored by the UE.

7. The method according to claim 6, wherein the wireless technology to be monitored is at least one of: long term evolution inter-frequency, global system for mobile communication enhanced data rates for global evolution radio access network, universal mobile telecommunications system terrestrial radio access network, code division multiple access 2000, 802.11, 802.16, and 802.21.

8. The method according to claim 4, wherein said scheduling includes scheduling a different measurement gap length for each measurement purpose requested by the UE.

9. The method according to claim 8, wherein a different measurement gap is scheduled for each wireless technology to be monitored by the UE.

10. The method according to claim 9, wherein the wireless technology to be monitored is at least one of: long term evolution inter-frequency, global system for mobile communication enhanced data rates for global evolution radio access network, universal mobile telecommunications system terrestrial radio access network, code division multiple access 2000, 802.11, 802.16, and 802.21.

11. The method according to claim 4, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length.

12. The method according to claim 4, further comprising:
receiving an indication that the UE completed taking its measurements before the end of the measurement gap; and
re-allocating radio resources assigned to the measurement gap for other purposes.

13. The method according to claim 4, further comprising:
receiving a request that the UE needs additional time to take its measurements;
scheduling an extended measurement gap; and
signaling extended measurement gap information to the UE.

14. The method according to claim 4, further comprising:
determining a length of time between consecutive measurement gaps.

15. The method according to claim 14, wherein said determining includes:
receiving a velocity measurement for the UE;
comparing the UE velocity measurement against a plurality of thresholds; and
determining the length of time based on the comparison result.

16. The method according to claim 15, wherein if the UE velocity is greater than a high velocity threshold for a predetermined period of time, then using a short length of time.

17. The method according to claim 15, wherein if the UE velocity is between a high velocity threshold and a low velocity threshold for a predetermined period of time, then using a medium length of time.

18. The method according to claim 15, wherein if the UE velocity is below a low velocity threshold for a predetermined period of time, then using a long length of time.

19. The method according to claim 14, wherein said determining includes:
receiving a pathloss measurement for the UE;
comparing the UE pathloss measurement against a plurality of thresholds; and
determining the length of time based on the comparison result.

20. The method according to claim 19, wherein if the UE pathloss is greater than a high pathloss threshold for a predetermined period of time, then using a short length of time.

21. The method according to claim 19, wherein if the UE pathloss is between a high pathloss threshold and a low pathloss threshold for a predetermined period of time, then using a medium length of time.

22. The method according to claim 19, wherein if the UE pathloss is below a low pathloss threshold for a predetermined period of time, then using a long length of time.

23. A user equipment (UE) configured to take measurements during a measurement gap, comprising:
a UE measurement device configured to take UE-specific measurements;
a measurement gap device in communication with said UE measurement device, said measurement gap device configured to:
receive the UE-specific measurements;
request a measurement gap from a wireless network, the request including the UE-specific measurements; and
receive measurement gap information from the network; and
an external measurement device in communication with said measurement gap device, said external measurement device configured to:
receive measurement gap information from said measurement gap device;
request external measurements during the measurement gap; and
receive the external measurements.

24. The UE according to claim 23, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length.

25. The UE according to claim 23, wherein said external measurement device is further configured to request an extended measurement gap from said measurement gap device.

26. The UE according to claim 25, wherein said measurement gap device is further configured to request the extended measurement gap.

27. A user equipment (UE) configured to take measurements during a measurement gap, comprising:
a measurement device configured to:
take UE-specific measurements;
receive measurement gap information;
request external measurements during the measurement gap; and
receive the external measurements; and
a measurement gap device in communication with said measurement device, said measurement gap device configured to:
receive the UE-specific measurements;
request a measurement gap from a wireless network, the request including the UE-specific measurements; and
receive the measurement gap information from the network.

28. The UE according to claim 27, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length.

29. The UE according to claim 27, wherein said measurement device is further configured to request an extended measurement gap from said measurement gap device.

30. The UE according to claim 29, wherein said measurement gap device is further configured to request the extended measurement gap from the network.

31. A base station configured to assign a measurement gap, comprising:
a measurement gap device configured to:
receive a measurement gap request from a user equipment (UE), the request including UE-specific measurements;
schedule the measurement gap based on the measurements; and
signal measurement gap information to the UE.

32. The base station according to claim 31, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length.

33. The base station according to claim 31, wherein said measurement gap device is further configured to:
receive a request that the UE needs additional time to take its measurements;
schedule an extended measurement gap; and
signal the extended measurement gap information to the UE.

34. The base station according to claim 31, further comprising:
a radio resource allocator configured to:
receive an indication from the UE that the UE has completed taking its measurements before the end of the measurement gap; and
re-allocate radio resources assigned to the measurement gap for other purposes.

35. A user equipment (UE) configured to take measurements during a measurement gap, comprising:
a UE measurement device configured to take UE-specific measurements;
a measurement gap device in communication with said UE measurement device, said measurement gap device configured to:
receive the UE-specific measurements;
request a measurement gap from a wireless network, the request including the UE-specific measurements; and
receive measurement gap information from the network, wherein the measurement gap information includes at least one of: a number of measurement purposes, an enumerated list of measurement purposes, a measurement gap pattern scheme, an enumerated pairing between a measurement gap pattern to different measurement purposes, a number of different gap types in one gap pattern, a sequence of measurement purposes in one gap pattern, a number of measurement purposes in one gap of a gap pattern, a sequence of measurement purposes in one gap, measurement gap pattern parameters, a gap pattern identifier, a starting measurement gap sequence number, a measurement gap length, a measurement gap duration, and a measurement gap pattern length; and
an external measurement device in communication with said measurement gap device, said external measurement device configured to:
receive measurement gap information from said measurement gap device;
request external measurements during the measurement gap; and
receive the external measurements.
